(19) United States
(12) Patent Application Publication
(10) Pub. No.: US 2026/0104188 A1
(43) Pub. Date: Apr. 16, 2026

(54) Electronic Expansion Valve

(71) Applicant: ZHEJIANG DUNAN ARTIFICIAL ENVIRONMENT CO., LTD., Shaoxing, Zhejiang (CN)

(72) Inventors: Guanjun XU, Shaoxing, Zhejiang (CN); Jun ZHAO, Shaoxing, Zhejiang (CN); Yuchen HE, Shaoxing, Zhejiang (CN); Hongfeng HUANG, Shaoxing, Zhejiang (CN)

(73) Assignee: ZHEJIANG DUNAN ARTIFICIAL ENVIRONMENT CO., LTD., Shaoxing, Zhejiang (CN)

(21) Appl. No.: 19/113,767

(22) PCT Filed: Sep. 4, 2023
(86) PCT No.: PCT/CN2023/116836

§ 371 Date: Mar. 20, 2025

(30) Foreign Application Priority Data
Sep. 20, 2022 (CN) 202211145110.8

(51) Int. Cl. F25B 41/34; F16K 1/44; F16K 1/46

(52) U.S. Cl. CPC F25B 41/34; F16K 1/443; F16K 1/465

(57) ABSTRACT

An electronic expansion valve, including a valve seat portion, a sealing gasket and a valve head, the valve seat portion having a valve cavity and a first flow passage, the sealing gasket being sealingly fitted with the valve seat portion, being disposed around the first flow passage and having a second flow passage, the first flow passage being in communication with the second flow passage, the valve head being movably arranged in the valve cavity, the second flow passage, when open, being in communication with the valve cavity, wherein the first flow passage and the second flow passage form a variable-diameter flow passage, with the flow areas at both ends of the variable-diameter flow passage being denoted as S1 and S2 respectively, and a minimum flow area in the middle of the variable-diameter flow passage being denoted as S3, wherein S3<S1 and S3<S2.

This application claims priority to Patent Application No. 202211145110.8, filed with the China National Intellectual Property Administration on Sep. 20, 2022, and titled “Electronic Expansion Valve”.

### TECHNICAL FIELD

The present application relates to the technical field of electronic expansion valves, specifically to an electronic expansion valve.

### BACKGROUND

Most electronic expansion valves exhibit internal leakage even after being closed. For large-caliber electronic expansion valves with low internal leakage, it is required that the internal leakage be minimal when closed, meaning the valves must have an on-off function. Additionally, a Cv value must meet certain requirements, which means the Cv value must be relatively large. The Cv value represents a flow capacity of a component for liquids, i.e., a flow coefficient, also known as a Kv value.

In an existing electronic expansion valve, a flow passage is opened and closed by a movement of a valve head, thereby realizing the on-off function of the electronic expansion valve. The flow passage cooperating with the valve head is typically a straight flow passage with a fixed flow area. When the valve head opens the flow passage, vortices may easily form at an end of a fluid in the flow passage near the valve head end, which affects the flow capacity of the flow passage, resulting in a decreased Cv value. Therefore, the flow passage structure in the existing electronic expansion valve presents an issue of poor flow capacity.

### SUMMARY

The present application provides an electronic expansion valve to solve a problem of poor flow capacity of electronic expansion valves in the prior art.

To solve the above problem, provided in the present application is an electronic expansion valve, including a valve seat portion being provided with a valve cavity and a first flow passage; a sealing gasket located in the valve seat portion and fitting with the valve seat portion, the sealing gasket being disposed around the first flow passage, the sealing gasket being provided with a second flow passage, and the first flow passage being in communication with the second flow passage; and a valve head movably arranged in the valve cavity to open and close the second flow passage, the second flow passage, when open, being in communication with the valve cavity, and a hardness of the valve head and the valve seat portion being both greater than a hardness of the sealing gasket, wherein the first flow passage and the second flow passage form a variable-diameter flow passage, flow areas at both ends of the variable-diameter flow passage being denoted as S1 and S2, respectively, and a minimum flow area in a middle of the variable-diameter flow passage being denoted as S3, wherein S3<S1 and S3<S2.

In some embodiments, the minimum flow area in the middle of the variable-diameter flow passage is located in the first flow passage and/or the second flow passage.

In some embodiments, an inner surface of the variable-diameter flow passage is an arc-shaped surface; or an inner surface of the variable-diameter flow passage includes a plurality of conical surfaces.

In some embodiments, in a direction where the first flow passage faces the valve cavity, an inner surface of the second flow passage includes a first annular surface, a second annular surface and a third annular surface that are connected in sequence, the first annular surface being a cylindrical surface or a conical surface, the second annular surface being a conical surface, and the third annular surface being a cylindrical surface or a conical surface, wherein an end of the conical surface in the second flow passage with a larger opening faces the valve cavity.

In some embodiments, on a cross-section passing through an axis of the first flow passage, an angle between the first annular surface and the axis of the first flow passage is denoted as A1, an angle between the second annular surface and the axis of the first flow passage is denoted as A2, and an angle between the third annular surface and the axis of the first flow passage is denoted as A3, wherein A1<A2<A3.

In some embodiments, 0≤A1≤10°, 6°≤A2≤26°, and 40°≤A3≤60°.

In some embodiments, in a direction where the second flow passage faces the first flow passage, an inner surface of the first flow passage includes a fourth annular surface and a fifth annular surface that are connected in sequence, the fourth annular surface being a cylindrical surface or a conical surface, and the fifth annular surface being a conical surface, wherein an end of the conical surface in the first flow passage with a larger opening faces away from the valve cavity.

In some embodiments, on a cross-section passing through an axis of the second flow passage, an angle between the fourth annular surface and the axis of the second flow passage is denoted as B1, and an angle between the fifth annular surface and the axis of the second flow passage is denoted as B2, wherein B1<B2.

In some embodiments, 0≤B1≤10°, and 2°≤B2≤25°.

In some embodiments, the sealing gasket is provided with an annular sealing surface on a side facing the valve cavity, the annular sealing surface is disposed around the second flow passage, and an outer diameter of the valve head is greater than an inner diameter of the second flow passage, where, when the valve head abuts against the annular sealing surface, the valve head closes the second flow passage.

In some embodiments, the valve seat portion includes a main valve seat and an auxiliary valve seat connected with each other, the main valve seat is provided with the valve cavity, the auxiliary valve seat is provided with the first flow passage, the auxiliary valve seat is further provided with an annular groove, and the sealing gasket is disposed in the annular groove.

In some embodiments, the auxiliary valve seat includes a main body and an annular cylinder arranged on the main body, the main body is provided with the first flow passage, the annular cylinder is provided with the annular groove, the main body is fixedly connected with the main valve seat, and an end of the annular cylinder away from the main body is riveted to the sealing gasket; and the electronic expansion valve further includes a first connecting pipe and a second connecting pipe, the first connecting pipe is connected with the main valve seat and is in communication with the valve cavity, the second connecting pipe being connected to the main body and being in communication with the first flow passage, and fluid areas of the first connecting pipe and the second connecting pipe are both greater than S3.

In some embodiments, the sealing gasket is provided with a first annular chamfer on a side facing the valve cavity, the first annular chamfer is disposed around an outer side of the annular sealing surface; the sealing gasket is provided with a second annular chamfer on a side facing the auxiliary valve seat, the second annular chamfer is disposed around the second flow passage; and the auxiliary valve seat is provided with a third annular chamfer on a side facing the sealing gasket, the third annular chamfer is disposed around the first flow passage.

By applying the technical solution of the present application, an electronic expansion valve is provided. The electronic expansion valve includes a valve seat portion, a sealing gasket and a valve head, the valve seat portion being provided with a valve cavity and a first flow passage, the sealing gasket being located in the valve seat portion and fitting with the valve seat portion, the sealing gasket being disposed around the first flow passage, the sealing gasket being provided with a second flow passage, the first flow passage being in communication with the second flow passage, the valve head being movably arranged in the valve cavity to open and close the second flow passage, the second flow passage, when open, being in communication with the valve cavity, and a hardness of the valve head and the valve seat portion being both greater than a hardness of the sealing gasket, wherein the first flow passage and the second flow passage form a variable-diameter flow passage, flow areas at both ends of the variable-diameter flow passage being denoted as S1 and S2, respectively, and a minimum flow area in a middle of the variable-diameter flow passage being denoted as S3, wherein S3<S1 and S3<S2. In this solution, the flow passages in the sealing gasket and the valve seat portion form the variable-diameter flow passage, and the minimum flow area in the middle of the variable-diameter flow passage is smaller than the flow passage areas at both ends, i.e., the variable-diameter flow passage is a structure in which the middle is thin and two ends are thick. By adopting this structure, compared with a straight flow passage, a flow velocity of a fluid increases when flowing through the variable-diameter flow passage. The increased flow velocity is able to prevent or reduce the formation of vortices near the valve head, thus avoiding or reducing the impact of vortices on the flow capacity. Therefore, this solution effectively improves the flow capacity of the electronic expansion valve, thereby increasing the Cv value. Furthermore, this solution uses the cooperation between the sealing gasket and the valve head to open and close the flow passages. Compared with a rigid structure, the sealing effect is better, reducing internal leakage of the electronic expansion valve and ensuring the reliable on/off functionality of the electronic expansion valve.

### BRIEF DESCRIPTION OF THE DRAWINGS

The accompanying drawings, which constitute a part of the present application, are used for providing a further understanding of the present application; and illustrative embodiments of the present application and descriptions thereof are intended to explain the present application and are not construed to unduly limit the present application. In the drawings:

FIG. 1 shows a structural schematic view of an electronic expansion valve according to an embodiment of the present application;

FIG. 2 shows a schematic view of the assembly of an auxiliary valve seat and a sealing gasket in FIG. 1; and

FIG. 3 shows a partial enlarged view of FIG. 2.

The following reference signs are involved in the accompanying drawings:
10, valve seat portion; 11, valve cavity; 12, first flow passage; 121, fourth annular surface; 122, fifth annular surface; 13, main valve seat;
14, auxiliary valve seat; 141, annular groove; 142, main body; 143, annular cylinder; 20, sealing gasket; 21, second flow passage; 211, first annular surface; 212, second annular surface; 213, third annular surface; 22, annular sealing surface; 30, valve head; 41, first connecting pipe; 42, second connecting pipe.

### DETAILED DESCRIPTION OF THE EMBODIMENTS

The technical solution in embodiments of the present application will be clearly and completely described below with reference to the accompanying drawings in the embodiments of the present application. Apparently, the embodiments to be described are only a part rather than all of the embodiments of the present application. The following description of at least one exemplary embodiment is merely illustrative in nature and is in no way intended to limit the application and any application or use thereof. Based on the embodiments of the present application, all other embodiments obtained by those of ordinary skill in the art without creative work shall fall within the scope of protection of the present application.

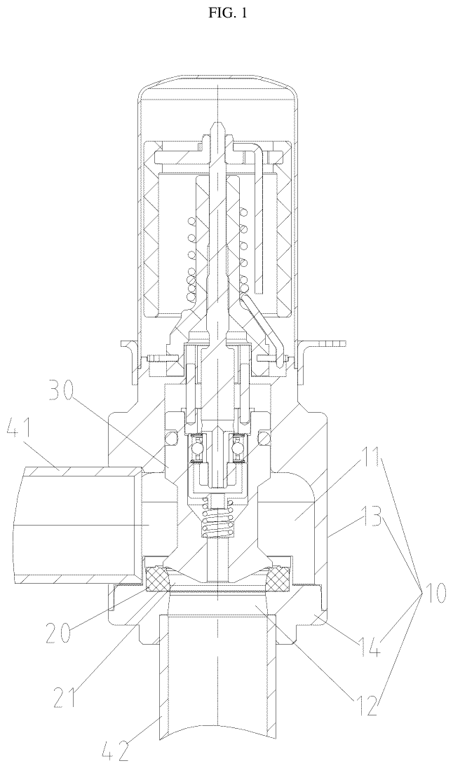

As shown in FIGS. 1 to 3, the embodiments of the present application provide an electronic expansion valve, including: a valve seat portion 10, the valve seat portion 10 being provided with a valve cavity 11 and a first flow passage 12; a sealing gasket 20 located in the valve seat portion 10 and fitting with the valve seat portion 10, the sealing gasket 20 is disposed around the first flow passage 12, the sealing gasket 20 being provided with a second flow passage 21, the first flow passage 12 being in communication with the second flow passage 21, and a hardness of a valve head 30 and he valve seat portion 10 being both greater than a hardness of the sealing gasket 20; and the valve head 30 movable disposed in the valve cavity 11 to open and close the second flow passage 21, the second flow passage 21, when open, being in communication with the valve cavity 11, wherein the first flow passage 12 and the second flow passage 21 form a variable-diameter flow passage, flow areas at both ends of the variable-diameter flow passage being denoted as S1 and S2, respectively, and a minimum flow area in a middle of the variable-diameter flow passage being denoted as S3, wherein S3<S1 and S3<S2. The sealing gasket 20 may be made of a soft material, such as rubber, such that the sealing effect is good.

In this solution, the second flow passage 21 and the first flow passage 12 in the sealing gasket 20 and the valve seat portion 10 form the variable-diameter flow passage, and the minimum flow area S3 in the middle of the variable-diameter flow passage is smaller than the flow passage areas at both ends, i.e., the variable-diameter flow passage is a structure in which the middle is thin and two ends are thick. By adopting this structure, compared with a straight flow passage, a flow velocity of a fluid increases when flowing through the minimum flow area of the variable-diameter flow passage. The increased flow velocity is able to prevent or reduce the formation of vortices in the fluid near the valve head 30, thus avoiding or reducing the impact of vortices on the flow capacity. Therefore, this solution effectively improves the flow capacity of the electronic expansion valve, thereby increasing the Cv value. Furthermore, this solution uses the cooperation between the sealing gasket 20 and the valve head 30 to open and close the flow passages. Compared with a rigid structure, the sealing effect is better, reducing internal leakage of the electronic expansion valve and ensuring the reliable on/off functionality of the electronic expansion valve. In this solution, the variable-diameter flow passage utilizes the Laval nozzle principle.

The position of the minimum flow area in the middle of the variable-diameter flow passage is located at the position in the first flow passage 12, close to the second flow passage 21, or at the position in the second flow passage 21, close to the first flow passage 12, or at the position where the first flow passage 12 and the second flow passage 21 are close to each other.

In this solution, an inner surface of the variable-diameter flow passage may be an arc-shaped surface, which reduces fluid resistance and allows smoother flow. For example, the inner surface of the variable-diameter flow passage may be an elliptical surface. Alternatively, the inner surface of the variable-diameter flow passage includes a plurality of conical surfaces. Using the plurality of conical surfaces with varying diameters is able to achieve an effect of variable diameters and increased flow velocity, and this method is able to reduce the manufacturing difficulty.

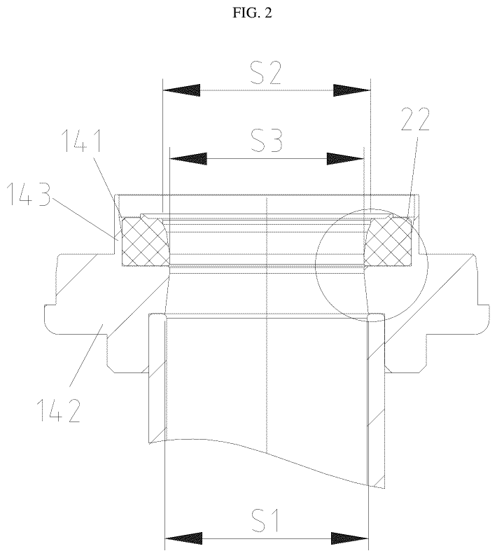

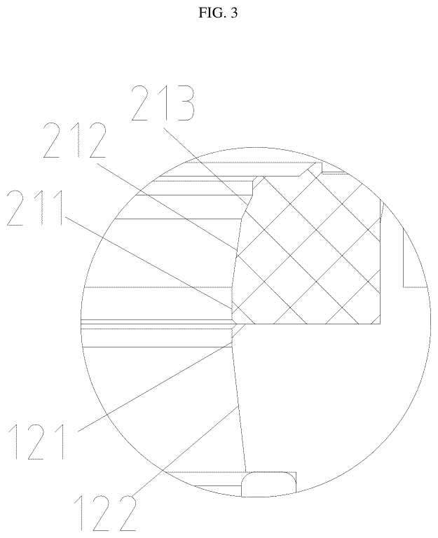

As shown in FIGS. 2 and 3, in a direction where the first flow passage 12 faces the valve cavity 11, an inner surface of the second flow passage 21 includes a first annular surface 211, a second annular surface 212 and a third annular surface 213 that are connected in sequence, the first annular surface 211 being a cylindrical surface or a conical surface, the second annular surface 212 being a conical surface, and the third annular surface 213 being a cylindrical surface or a conical surface, wherein an end of the conical surface in the second flow passage 21 with a larger opening faces the valve cavity 11. The change in flow area from small to large is achieved through the arrangement of the first annular surface 211, second annular surface 212, and third annular surface 213, which also facilitates manufacturing.

In one specific embodiment, on a cross-section passing through an axis of the first flow passage 12, an angle between the first annular surface 211 and the axis of the first flow passage 12 is denoted as A1, an angle between the second annular surface 212 and the axis of the first flow passage 12 is denoted as A2, and an angle between the third annular surface 213 and the axis of the first flow passage 12 is denoted as A3, wherein A1<A2<A3. The minimum flow area of the variable-diameter flow passage is located upstream of the first annular surface 211 or at the first annular surface 211. This arrangement enables the flow areas of the three annular surfaces to increase successively from small to large, thereby forming a Laval nozzle.

In some embodiments, 0≤A1≤10°, 6°≤A2≤26°, and 40°≤A3≤60°. By setting the angles between the first annular surface 211, second annular surface 212, and third annular surface 213, and the axis of the first flow passage 12 within the above ranges, the fluid passing through this structure has a higher velocity, thereby avoiding or reducing the formation of vortices in the fluid close to the valve head 30, and improving the Cv value of the electronic expansion valve.

As shown in FIGS. 2 and 3, in a direction where the second flow passage 21 faces the first flow passage 12, an inner surface of the first flow passage 12 includes a fourth annular surface 121 and a fifth annular surface 122 that are connected in sequence, the fourth annular surface 121 being a cylindrical surface or a conical surface, and the fifth annular surface 122 being a conical surface, wherein an end of the conical surface in the first flow passage 12 with a larger opening faces away from the valve cavity 11. The fluid enters the valve cavity from the first flow passage 12. Through the above arrangement, as the fluid flows through the first flow passage 12, the flow area undergoes a process of decreasing from large to small, which increases the fluid velocity, thereby avoiding or reducing the formation of vortices as the fluid flows near the valve head 30, and improving the Cv value of the electronic expansion valve. The fifth annular surface 122 may be configured as a plurality of conical surfaces that are connected sequentially.

In some embodiments, on a cross-section passing through an axis of the second flow passage 21, an angle between the fourth annular surface 121 and the axis of the second flow passage 21 is denoted as B1, and an angle between the fifth annular surface 122 and the axis of the second flow passage 21 is denoted as B2, wherein B1<B2. This configuration helps to achieve a change in flow area and also facilitates manufacturing.

0<B1≤10°, and 2°≤B2≤25°. By setting the angles between the fourth and fifth annular surfaces 121 and 122 and the axis of the second flow passage 21 within the above ranges, the fluid passing through this structure has a higher velocity, thereby avoiding or reducing the formation of vortices in the fluid near the valve head 30, and improving the Cv value of the electronic expansion valve. In this solution, the second flow passage 21 and the first flow passage 12 are arranged coaxially.

As shown in FIGS. 1 and 2, the sealing gasket 20 is provided with an annular sealing surface 22 on a side facing the valve cavity 11, the annular sealing surface 22 is disposed around the second flow passage 21, and an outer diameter of the valve head 30 is greater than an inner diameter of the second flow passage 21, where, when the valve head 30 abuts against the annular sealing surface 22, the valve head 30 closes the second flow passage 21. The valve head 30 abuts against the annular sealing surface 22, compressing the sealing gasket 20, which increases the contact area and enhances the sealing effect, thereby achieving low internal leakage or no internal leakage after the valve is closed. Compared with the prior art, the structure cooperating with the valve head 30 in this solution is a soft sealing structure, with the sealing surface located on an end face of the sealing gasket 20 rather than on an inner wall of the flow passage, thereby avoiding wear and damage to the inner wall of the flow passage, and achieving a large contact area and reliable sealing.

In this solution, the valve seat portion 10 may be configured as a one-piece structure for higher structural strength, or the valve seat portion 10 be configured as a split structure for easier manufacturing.

In one specific embodiment, the valve seat portion 10 includes a main valve seat 13 and an auxiliary valve seat 14 connected with each other, the main valve seat 13 is provided with the valve cavity 11, the auxiliary valve seat 14 is provided with the first flow passage 12, the auxiliary valve seat 14 is further provided with an annular groove 141, and the sealing gasket 20 is disposed in the annular groove 141. The valve seat portion 10 is configured as two split parts, allowing for separate manufacturing. The sealing gasket 20 is able to be disposed in the annular groove 141, and then the main valve seat 13 and auxiliary valve seat 14 are connected, facilitating assembly.

In some embodiments, the auxiliary valve seat 14 includes a main body 142 and an annular cylinder 143 arranged on the main body 142, the main body 142 is provided with the first flow passage 12, the annular cylinder 143 is provided with the annular groove 141, the main body 142 is fixedly connected with the main valve seat 13, and an end of the annular cylinder 143 away from the main body 142 is riveted to the sealing gasket 20; and the electronic expansion valve further includes a first connecting pipe 41 and a second connecting pipe 42, the first connecting pipe 41 is connected with the main valve seat 13 and is in communication with the valve cavity 11, the second connecting pipe 42 being connected to the main body 142 and being in communication with the first flow passage 12, and fluid areas of the first connecting pipe 41 and the second connecting pipe 42 are both greater than S3. The sealing gasket 20 is fixed by riveting, ensuring a reliable connection. A portion of the main body 142 penetrates into the main valve seat 13, together being axially limited by a stepped structure. The main body 142 and the main valve seat 13 are able to be connected by interference fit, welding, or other methods.

In some embodiments, the sealing gasket 20 is provided with a first annular chamfer on a side facing the valve cavity 11, the first annular chamfer is disposed around an outer side of the annular sealing surface 22; the sealing gasket 20 is provided with a second annular chamfer on a side facing the auxiliary valve seat 14, the second annular chamfer is disposed around the second flow passage 21; and the auxiliary valve seat 14 is provided with a third annular chamfer on a side facing the sealing gasket 20, the third annular chamfer is disposed around the first flow passage 12. The arrangement of the annular chamfers is able to prevent burr formation during processing, thereby ensuring the precision of the electronic expansion valve.

In some embodiments, in one specific embodiment, the valve head 30 is provided with a sealing surface and a flow guiding surface, the sealing surface is disposed around the flow guiding surface, i.e., the sealing surface is annular, and the sealing surface and the annular sealing surface 22 are sealingly fitted. The flow guiding surface is a conical surface. Through the arrangement of the conical flow guiding surface, the resistance of the fluid is able to be reduced when passing through same, thereby improving the flow capacity of the fluid. In some embodiments, the valve head 30 is provided with a clearance groove, and the clearance groove is located between the sealing surface and the flow guiding surface. The valve head 30 will inevitably have burrs or partial flanging during manufacturing, and by providing the clearance groove, the burrs or flanging generated during manufacturing will be located in the clearance groove, which avoids the burrs or partial flanging from affecting the sealing fit, thus ensuring the sealing effect.

The foregoing is merely an embodiment of the present application and is not intended to limit the present application which may be subject to various modifications and variations to those skilled in the art. Any modification, equivalent replacement, improvement, etc. made within the spirit and principles of the present application should fall within the scope of protection of the present application.

1. An electronic expansion valve, comprising:
a valve seat portion, the valve seat portion being provided with a valve cavity and a first flow passage;
a sealing gasket located inside the valve seat portion and fitting with the valve seat portion, the sealing gasket being disposed around the first flow passage, the sealing gasket being provided with a second flow passage, and the first flow passage being in communication with the second flow passage; and
a valve head movably arranged inside the valve cavity to open and close the second flow passage, the second flow passage, when open, being in communication with the valve cavity, and a hardness of the valve head and the valve seat portion being greater than a hardness of the sealing gasket;
wherein the first flow passage and the second flow passage form a variable-diameter flow passage, flow areas at both ends of the variable-diameter flow passage being denoted as S1 and S2, respectively, and a minimum flow area in a middle of the variable-diameter flow passage being denoted as S3, wherein S3<S1 and S3<S2.

2. The electronic expansion valve according to claim 1, wherein the minimum flow area in the middle of the variable-diameter flow passage is located in the first flow passage and/or the second flow passage.

3. The electronic expansion valve according to claim 1, wherein an inner surface of the variable-diameter flow passage is an arc-shaped surface; or an inner surface of the variable-diameter flow passage comprises a plurality of conical surfaces.

4. The electronic expansion valve according to claim 1, wherein in a direction where the first flow passage faces the valve cavity, an inner surface of the second flow passage comprises a first annular surface, a second annular surface and a third annular surface that are connected in sequence, the first annular surface being a cylindrical surface or a conical surface, the second annular surface being a conical surface, and the third annular surface being a cylindrical surface or a conical surface, wherein an end of the conical surface in the second flow passage with a larger opening faces the valve cavity.

5. The electronic expansion valve according to claim 4, wherein on a cross-section passing through an axis of the first flow passage, an angle between the first annular surface and the axis of the first flow passage is denoted as A1, an angle between the second annular surface and the axis of the first flow passage is denoted as A2, and an angle between the third annular surface and the axis of the first flow passage is denoted as A3, wherein A1<A2 <A3.

6. The electronic expansion valve according to claim 5, wherein 0≤A1≤10°, 6°≤A2≤26°, and 40°≤A3≤60°.

7. The electronic expansion valve according to claim 1, wherein in a direction where the second flow passage faces the first flow passage, an inner surface of the first flow passage comprises a fourth annular surface and a fifth annular surface that are connected in sequence, the fourth annular surface being a cylindrical surface or a conical surface, and the fifth annular surface being a conical surface, wherein an end of the conical surface in the first flow passage with a larger opening faces away from the valve cavity.

8. The electronic expansion valve according to claim 7, wherein on a cross-section passing through an axis of the second flow passage, an angle between the fourth annular surface and the axis of the second flow passage is denoted as B1, and an angle between the fifth annular surface and the axis of the second flow passage is denoted as B2, wherein B1<B2.

9. The electronic expansion valve according to claim 8, wherein 0≤B1≤10°, and 2°≤B2≤25°.

10. The electronic expansion valve according to claim 1, wherein the sealing gasket is provided with an annular sealing surface on a side facing the valve cavity, the annular sealing surface is disposed around the second flow passage, and an outer diameter of the valve head is greater than an inner diameter of the second flow passage, wherein when the valve head abuts against the annular sealing surface, the valve head closes the second flow passage.

11. The electronic expansion valve according to claim 10, wherein the valve seat portion comprises a main valve seat and an auxiliary valve seat connected with each other, the main valve seat is provided with the valve cavity, the auxiliary valve seat is provided with the first flow passage, the auxiliary valve seat is further provided with an annular groove, and the sealing gasket is disposed in the annular groove.

12. The electronic expansion valve according to claim 11, wherein the auxiliary valve seat comprises a main body and an annular cylinder arranged on the main body, the main body is provided with the first flow passage, the annular cylinder is provided with the annular groove, the main body is fixedly connected with the main valve seat, and an end of the annular cylinder away from the main body is riveted to the sealing gasket; and the electronic expansion valve further comprises a first connecting pipe and a second connecting pipe, the first connecting pipe is connected with the main valve seat and is in communication with the valve cavity, the second connecting pipe is connected with the main body and is in communication with the first flow passage, and fluid areas of the first connecting pipe and the second connecting pipe are both greater than S3.

13. The electronic expansion valve according to claim 11, wherein the sealing gasket is provided with a first annular chamfer on a side facing the valve cavity, the first annular chamfer is disposed around an outer side of the annular sealing surface; the sealing gasket is provided with a second annular chamfer on a side facing the auxiliary valve seat, the second annular chamfer is disposed around the second flow passage; and the auxiliary valve seat is provided with a third annular chamfer on a side facing the sealing gasket, the third annular chamfer is disposed around the first flow passage.

14. The electronic expansion valve according to claim 1, wherein the valve head is provided with a sealing surface and a flow guiding surface, the sealing surface is annular and is disposed around the flow guiding surface, the sealing surface is in sealing fit with an end surface of the sealing gasket, and the flow guiding surface is a conical surface to reduce fluid resistance.
